(19) United States
(12) Patent Application Publication
(10) Pub. No.: US 2022/0329136 A1
(43) Pub. Date: Oct. 13, 2022

(54) SHAFT FOR A SLIP-RING ROTOR

(71) Applicant: Flender GmbH, 46395 Bocholt (DE)

(72) Inventors: DANIEL FRIEDL, Fürstenzell (DE); ROBERT GRUBER, Ruhstorf (DE); OLIVER MEMMINGER, Neuburg a. Inn (DE); SASA MIHAJLOVIC, Rubstorf a.d, Rott (DE); KLAUS SCHIFFERER, Neuhaus am Inn (DE); TOBIAS SPERL, Haarbach (DE); ANATOLI VOGEL, Passau (DE)

(73) Assignee: Flender GmbH, 46395 Bocholt (DE)

(21) Appl. No.: 17/635,965

(22) PCT Filed: Jul. 29, 2020
(86) PCT No.: PCT/EP2020/071381

§ 371 Date: Feb. 16, 2022

(30) Foreign Application Priority Data
Sep. 30, 2019 (EP) 19200484.4

(51) Int. Cl. H02K 13/00; H02K 7/00

(52) U.S. Cl. CPC H02K 13/003; H02K 7/003

(57) ABSTRACT

A shaft includes a bushing for a current conductor, and a holder for positioning the current conductor. The holder secures the current conductor in or over an inflection point of a curve of the current conductor.

The invention relates to a shaft having a bushing for a current conductor. Such shafts are present in particular in electric machines having slip ring rotors. Such electric machines also have in particular a brush holder of a slip ring system. The electric machine is in particular a dynamoelectrically excited machine. The invention also relates to a method for simulating the operation of the shaft and a corresponding computer program product.

Slip ring systems serve to introduce electrical excitation into the rotating part of a dynamoelectric machine, i.e. the rotor. Due to the increasingly high performance of dynamoelectric machines, for example generators of wind power plants, the transmissible electrical power required in this regard is becoming increasingly high. This results in increasingly high current strengths and/or higher voltages. This furthermore results in larger cross-sections of electric current conductors and/or greater insulation.

Due to the optimization of costs and installation space and to increasing performance requirements, in particular in the case of wind power plants, generators or motors and their components are becoming increasingly compact and are loaded with higher currents. In this case, the current-carrying current conductors, which are in particular stranded wires, and their cross-sections also need to be dimensioned or increased accordingly. The electrical connection between the rotor and the slip ring is realized for example with two 240 mm² (or greater) stranded control wires for each phase and is routed into the shaft through corresponding bores. The electric machine (i.e. in particular the dynamoelectric machine) relates in particular to a three-phase electric machine for a rotary current application. An increased weight of the stranded wires, i.e. the current conductors (owing to the greater diameter for the higher current strengths) can result in cracks in the potting material, wherein the potting material surrounds the current conductor. An object of the invention is to improve the routing of a current conductor through the shaft.

A solution to the problem is realized in the case of a shaft having the features of claim 1. Further configurations are realized for example according to claims 2 to 11. A solution to the problem is also realized in the case of a slip ring rotor, in particular of an asynchronous machine, which has a shaft according to one of the claims or according to one of the configurations described below. A further solution to the problem is realized according to a method according to claim 12 and, in the case of a computer program product, according to claim 13.

A shaft has a bushing for a current conductor. The shaft furthermore has a holder for positioning the current conductor. The shaft is in particular partially hollow, wherein one or more current conductors extend in the part of the shaft which is hollow. The shaft is therefore in particular constructed, in part or as whole, as a hollow shaft. In particular, current conductors for a rotary current system extend in the shaft. The shaft is provided in particular for a slip ring rotor or the shaft is part of the slip ring rotor. The slip ring rotor is provided in particular for an asynchronous machine. The asynchronous machine is for example a double-fed asynchronous machine. The asynchronous machine is for example a generator and/or a motor. The asynchronous machine is therefore in particular an electrically excited dynamoelectric machine.

The slip ring rotor has in particular a slip ring system. The slip rings can be contacted via brushes.

As a result of the holder for positioning the current conductor, this latter can be held in a particular position. In this case, the holder can be designed to hold a current conductor or a plurality of current conductors. Examples here are two, three or four current conductors. The current conductors, which are held by means of a holder, relate in particular to a phase of a rotary current. The current conductors are for example solid or constructed as stranded wires. Copper or aluminum, for example, can be used as the material for the current conductor. As a result of the holder, the current conductor (or the current conductors—i.e. even if only one current conductor which is held is mentioned below, this also applies to a plurality of current conductors which are held by the holder) can be held in a predetermined position before potting. A resin or a resin compound, for example, can be used for potting. Alternatively or in combination, the holder can hold the current conductor (or the current conductors) in a predetermined position for binding. As a result of the current conductor(s) being held in a predetermined position by the holder, it can be achieved for example that the bend radii of the current conductor, in particular in the region of the holder, are not smaller than a minimum value.

In one configuration of the shaft, the holder secures the at least one current conductor in or over an inflection point of a curve of the at least one current conductor. If an inflection point is present, the current conductor (i.e. one or more current conductors) can be routed out of the shaft, or routed into the shaft, with defined bend radii. These bend radii are greater than the minimum permissible bend radius for the corresponding conductor. The minimum bend radius depends for example on the material, on the cross-sectional shape and/or on the nature (e.g. solid material or stranded wire). If the current conductor is secured in or over the inflection point of the curve of the at least one current conductor by means of the holder, the holder is located in the region of the inflection point, i.e. in particular at least also at the in point.

In one configuration of the shaft, the holder has a base and a cover. The base can serve as a type of bed on which the current conductor is placed. The cover then encloses the current conductor. The current conductor is therefore positioned between the base and the cover. The holder can hold two stranded wires, for example. In one configuration, it is furthermore possible that the holder is secured or held with respect to the shaft by means of at least one plastic cable holder.

In one configuration of the shaft, the shaft has a slot for receiving the current conductor. A slot is in particular an opening in an otherwise predominantly circular shaft. Such an opening can be achieved for example by means of a milling procedure. The opening is for example a groove in the shaft. The slot has in particular a longitudinal alignment. The longitudinal alignment is parallel or substantially parallel to the axis of the shaft. In one configuration of the shaft, to facilitate the placement of the current conductors, i.e. in particular the stranded wires, and to ensure that the minimum bend radii are observed, three slots, one for each phase, are milled into the shaft.

In one configuration of the shaft, this has three or more slots. The slots are in particular uniformly distributed over the circumference of the shaft. In one configuration of the shaft, the slots are offset from one another in terms of their longitudinal alignment. In a further configuration of the shaft, which, as above and below, can also be combined with further configurations here, one slot is provided for one phase in each case, wherein in particular one slot receives two or more current conductors in each case, wherein the current conductors are in particular stranded wires. By way of example, two stranded wires are placed in each slot and then secured by a plastic cable holder. The stranded wire is an electrical conductor comprising individual wires, which are in particular thin. As a result of the individual conductors, the stranded wire is easier to bend than a current conductor comprising a solid material. The individual wires of the stranded wire can have a common insulating sheath.

In one configuration of the shaft, the slot receives the holder at least in part. The holder can therefore be positioned with respect to the shaft.

In one configuration of the shaft, the holder has a shape which corresponds to the shape of the current conductor. The shape can be for example groove-like. The groove has in particular a semi-circular cross-section. This serves for better positioning of the current conductor by means of the holder. The holder (cable holder, i.e. holder of the current conductor) can therefore be adapted to the diameter of the current conductor (in particular the stranded-wire diameter) in terms of its shape. In particular, the holder is also adapted to the shape of the slot in the shaft. The holder can therefore ensure an optimum and preferably stress-free extent of the current conductor (in particular the stranded wire). This relates in particular to not only one current conductor, but a plurality of current conductors, in particular all current conductors which are routed out of the shaft or into the shaft via slots.

In one configuration of the shaft, the holder is fastened by means of a screw connection. The fastening takes place at the core of the shaft (shaft core). By using one or more screws, the holder can be quickly secured so that it is not necessary to wait for an adhesive to harden, for example, when manufacturing the shaft. By way of example, the holders (which are in particular manufactured from a plastic material (plastic cable holders)), are each fastened on the shaft by 2×M8 screws and therefore hold the stranded wires in position.

In one configuration of the shaft, the holder is potted. This contributes to additional securing. After potting of the holder, residual gaps between the shaft, the holder (the cable holder) and the current conductors (stranded wires) can be filled with potting compound, for example. In one configuration of the shaft, the current conductor is therefore potted.

In one configuration of the shaft, this has a binding in the region of the holder. The current conductors can therefore be additionally secured with or in their holders or holder. After the potting compound has hardened, the region of the shaft can therefore be bound and then impregnated with the fully assembled rotor, for example.

In one configuration of the shaft, the bushing is at an angle of 20 degrees to 30 degrees with respect to the axis of the shaft. Current conductors can therefore be inserted a large minimum bend radius.

A solution to the problem is revealed in a method for operating a shaft of the type described above or of the type described below, wherein the operation of the shaft is simulated. The method relates to the simulated operation of the shaft or a machine having the shaft. The electric machine has in particular a slip ring rotor. By simulating the operation of the machine or the shaft, it is possible to calculate centrifugal forces, for example, and/or also a thermal load. This enables conclusions to be drawn with regard to the nominal speed, the maximum speed and/or the service life, for example. A simulation of the dynamic behavior can also take place in conjunction with real operating data. Therefore, to this end, a torque, a speed and/or the corresponding change over time can be measured at the rotor shaft, for example. These variables can be used as input variables for the simulation. A simulation model can then be created more precisely, for example, if further information is used. This relates in particular to variables such as an electric voltage or an electric current. As a result of the simulation, the development of a digital twin is also possible. Monitoring can therefore take place in parallel with the operation of the machine, for example, in order to promptly detect wear or a potential fault, for example.

A computer program product can be provided, which has computer-executable program means and which, when executed on a computer device having processor means and data storage means, is suitable for carrying out a method according to one of the type described. Therefore, an underlying object can be achieved by a computer program product which is designed to simulate an operating behavior of the electric machine. The computer program product can also have a data interface, via which operating parameters, for example a speed and/or a machine current, can be specified. The computer program product can likewise also have a data interface for outputting simulation results. The computer program product can be developed as a so-called digital twin, for example.

The invention and further advantageous configurations of the invention are explained in more detail with the aid of exemplary embodiments illustrated in principle, in which:

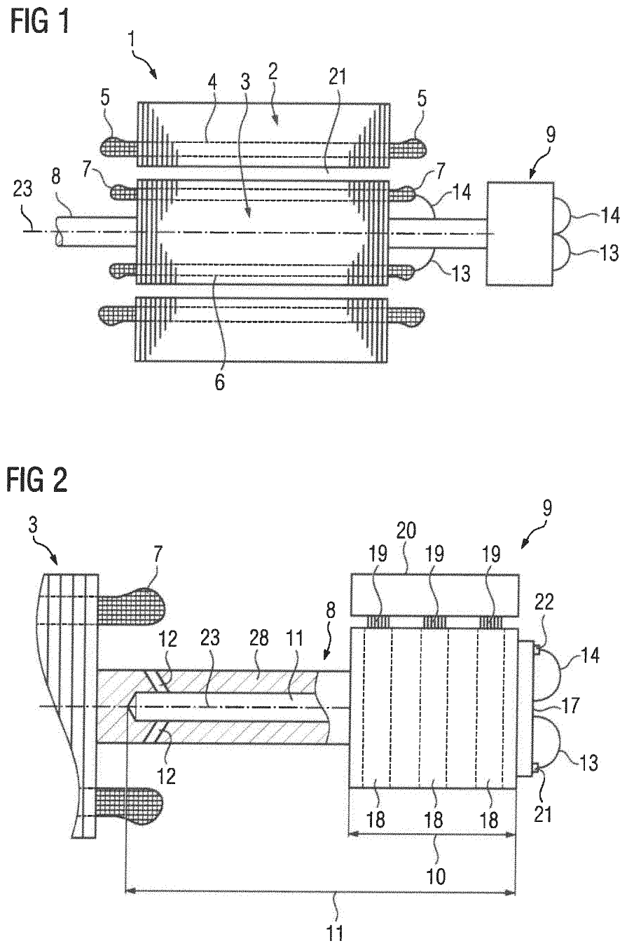

FIG. 1 shows an, in principle, double-fed asynchronous machine,

FIG. 2 shows a partial longitudinal section of the double-fed asynchronous machine,

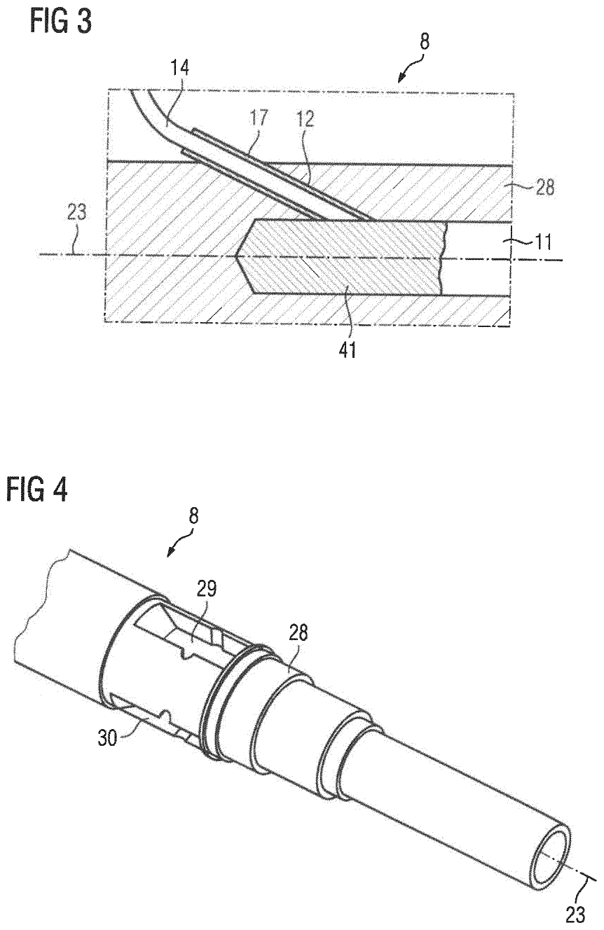

FIG. 3 shows a partial longitudinal section through a shaft,

FIG. 4 shows a perspective illustration of slots in the shaft,

FIG. 5 shows an enlarged perspective illustration of a slot in the shaft,

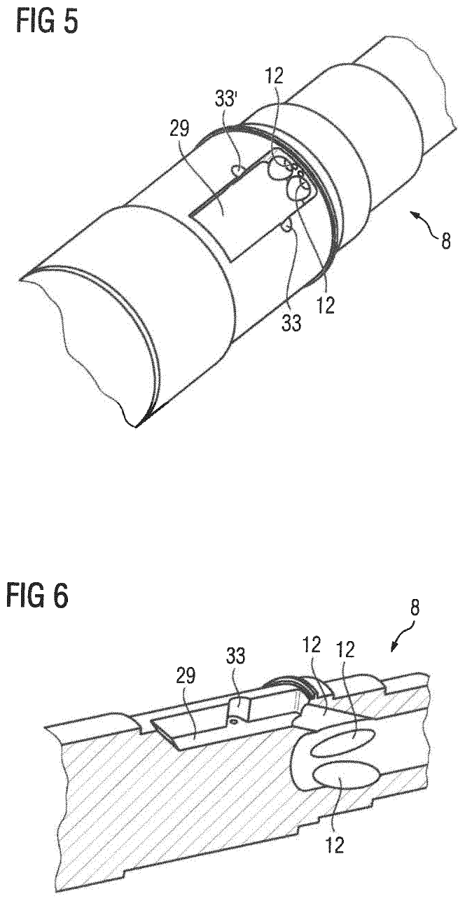

FIG. 6 shows a longitudinal section through a slot,

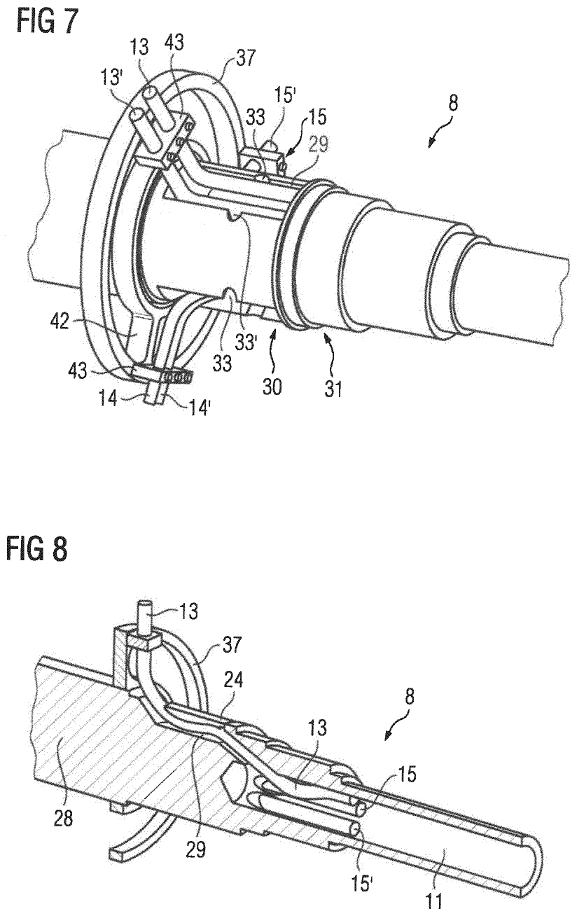

FIG. 7 shows a perspective illustration of a routing of current conductors via the slots,

FIG. 8 shows a perspective longitudinal section through a shaft,

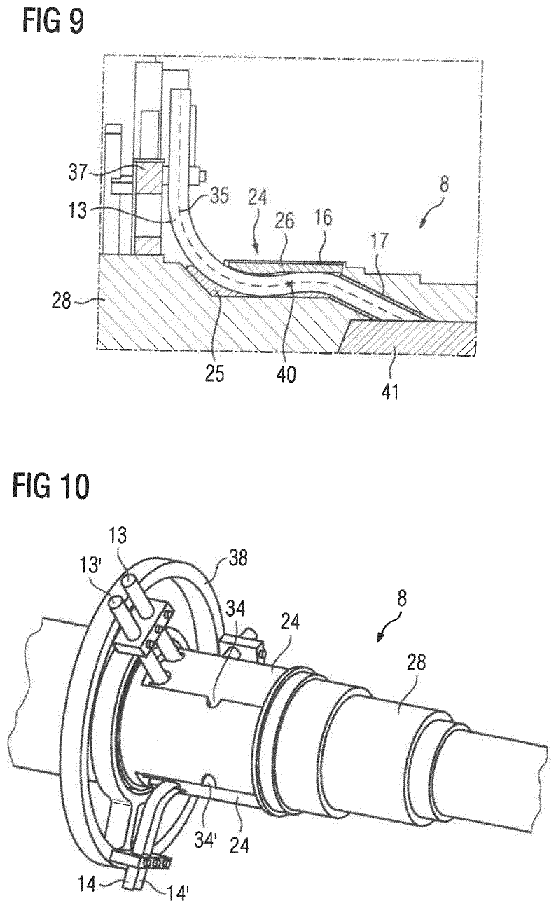

FIG. 9 shows a holder for routing the current conductor in the slot,

FIG. 10 shows a fastening of the current conductor on a fastening ring,

FIG. 11 shows the cover of the holder in a plan view,

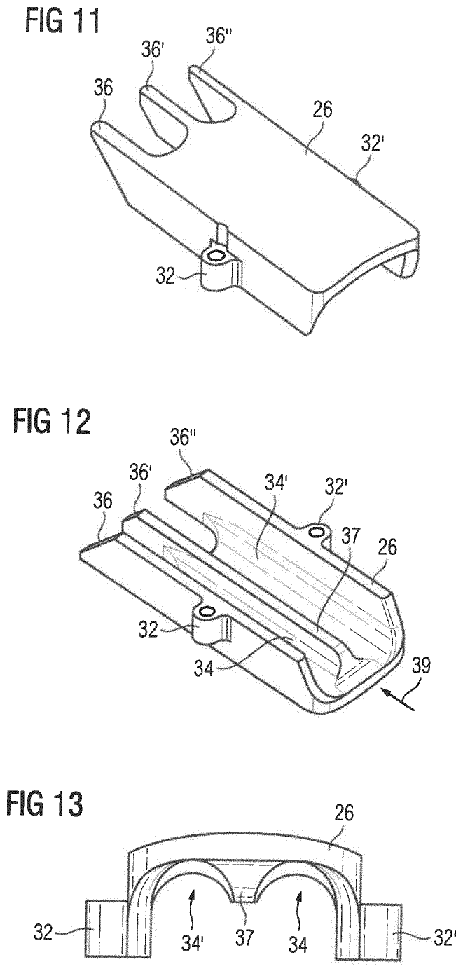

FIG. 12 shows the cover of the holder looking onto the skis which faces the current conductors, and

FIG. 13 shows the cover in a rear view.

In the following figures, similar elements are denoted by the same reference signs.

FIG. 1 shows a double-fed asynchronous machine 1 having a stator 2 and a slip ring rotor 3, wherein the stator 2 has a winding system 4 which has end windings 5 at the end faces of the stator 2. The slip ring rotor 3 also has a winding system 6, which likewise forms end windings 7. The slip ring rotor 3 is connected to a shaft 8, having an axis 23, in a torsion-resistant manner, which shaft likewise has a slip ring system 9 on an axial end, in particular the OS side (OS: operating side). In this case, the slip ring system 9 has slip rings 18 (see FIG. 2) rotating with the shaft 8, which, via supply lines 13 and 14, provide electric power to the slip ring rotor 3 via one or more brushes 19 (see FIG. 2) in each case, which are mounted on a brush holder 20 (see FIG. 2) in a stationary manner. The supply lines 13 and 14 are current conductors. In a three-phase rotary current system, there are at least three current conductors, wherein only 2 current conductors 13 and 14 are shown in the illustration according to FIG. 1. The current conductors 13 and 14 exit from bushings 12, wherein the bushings 12 can be realized as bores in the shaft 8, wherein the bushings 12 are illustrated in FIG. 2. The bores end in a hollow shaft portion 11 (see FIG. 2) of the shaft 8. If 150 mm² stranded wires are used, for example due to relatively low electric currents, the shaft bores can be drilled at an angle of 45°. Owing to the resultant more steeply angled exit and the smaller bend radius of the stranded wires, a cable clamp fastened on the rotor is sufficient to secure the stranded wires. If stranded wires which have a cross-section larger than 150 mm² are required owing to higher electric currents, problems can arise with regard to the bend radius.

FIG. 2 shows, in a more detailed illustration, the slip ring system 9 with part of the slip ring rotor 3. In this case, the supply lines 13 and 14 lead from contact points 21 and 22 on the slip ring system 9, via supply lines 13 and 14 inserted into a hollow shaft portion 11, to the bores 12 at the end of the hollow shaft portion 11 and can thus supply the winding system 6 of the slip ring rotor 3 with electric power. The bores 12 are bushings through a shaft core 28 for routing the current conductors 13 and 14. The shaft core 28 is in particular a solid material, in particular comprising steel. The slip ring system 9, which makes up an axial part of a hollow shaft portion 11 of the shaft 8, is mounted on the shaft portion 10. Such slip ring rotors 3 are used for example in wind power plants, which have double-fed asynchronous machines as a generator.

FIG. 3 shows a partial longitudinal section through the shaft 8. This shows, in an enlarged illustration, the passage of the current conductor 14 through the shaft core 28, which has an axis 23. In this case, the current conductor 14 is routed through a sleeve 17 in the bushing 12. The current conductor 14 is also located in a hollow shaft portion 11 in the shaft 8. The electrical connection between the rotor and the slip ring (not illustrated in FIG. 3) is realized for example by two 240 mm² stranded wires for each phase and routed into the shaft 8 through corresponding bores 12. The electric machine (i.e. in particular the dynamoelectric machine) is in particular a three-phase electric machine for a rotary current application, as is the case in wind generators. For mechanical securing, after the placement of the current conductor(s), the shaft bore, i.e. the hollow shaft portion 11, can then be at least partially filled with potting compound 41.

FIG. 4 shows a perspective illustration of slots 29 and 30 in the shaft 8 or in the shaft core 28. The shaft core 28 has three slots here, which are uniformly distributed over the circumference of the shaft core 28, wherein only two slots 29 and 30 are illustrated according to FIG. 4. Since 150 mm² stranded wires were hitherto used in wind generators owing to relatively low currents, the bushings (shaft bores), not shown in FIG. 4, could be drilled at an angle of ca. 45°. Owing to the resultant more steeply angled exit and the smaller bend radius of the stranded wires, a cable clamp fastened on the rotor was hitherto sufficient to secure the stranded wires. An increased weight of the stranded wires due to the greater diameter for higher current strengths in more powerful wind generators and an altered geometry of the bores as bushings for the current conductor, i.e. in particular for one or more stranded wires, at an angle of for example ca. 25° in the shaft 8, can cause cracks to occur, in particular when a potting material is present. It can be assumed from this that the stranded wires will become deformed. This in turn results in damage to the stranded wires and can consequently result in failure of the machine. As a result of using slots 29, 30, the geometrical extent of the stranded wires or the current conductors can be altered, in particular improved. The smaller the diameter of the current conductor, the smaller the minimum bend radius. With a small bend radius, it is possible to select a large angle of e.g. 40° to 50° in the shaft for the bushing. The greater the diameter of the current conductor (e.g. >=240 mm²), the greater the minimum bend radius. With a large minimum bend radius, it is necessary to select a larger angle of e.g. 20° to 30° in the shaft for the bushing. The angle relates to the longitudinal alignment of the bushing in relation to the axis 23. The use of slots 29, 30 adjoining the respective bushing can influence the applied bend radius of the current conductors. Cracks, which would otherwise be expected in an embodiment without slots, can thus be prevented from occurring as a result of a larger bend radius e.g. of stranded wires with large diameters. Deformation of the stranded wires can namely be assumed from the cracks. This in turn results in damage to the wires and can therefore result in failure of the machine. To facilitate the placement of the current conductors, in particular the stranded wires, and/or to ensure that the minimum bend radius is observed, at least three slots are milled into the shaft 8, i.e. into the shaft core 28. Only two slots 29, 30 are shown in FIG. 4, wherein the third slot is located on the rear side of the shaft illustrated in a perspective view. In one configuration of the shaft 8, one slot is provided for each electric phase (U, V, W).

FIG. 5 shows an enlarged perspective illustration of the slot 29 in the shaft 8. From a somewhat altered perspective, two bushings 12, through which current conductors can be routed, can now be seen in FIG. 5. The bushings 12 directly adjoin the slot 29. Notches 33, 33′ are also shown, in which protrusions 32, 32′ of a holder 24 can engage.

FIG. 6 shows a longitudinal section through the shaft 8 and through the slot 29 with the notch 33 and a bushing 12, which adjoins the slot 29. Two further bushings 12 are also shown, although they adjoin a different slot which is not shown in FIG. 6.

FIG. 7 shows a perspective illustration of the routing of current conductors 13, 13′, 14, 14′, 15, 15′. The routing of the current conductors 13, 13′ is shown in the still open slot 29. The slot 29 has notches 33, 33′. The current conductors 14, 14′ are routed in the slot 30. The current conductors 15, 15′ are routed in the slot 31, wherein the slot 31 in FIG. 7 is located on the rear side in this view due to the perspective illustration and is therefore not illustrated. The current conductors 13, 13′, 14, 14′ 15, 15′ are fastened on a web 37. The web 37 is designed to be annular and has a spoke 42. Two stranded wires are placed in each slot and then secured by a cable holder 43, which in particular comprises plastic material.

FIG. 8 shows a perspective longitudinal section through the shaft 8. It is shown how the holder 24 holds the current conductor 13 in the slot 29. It is furthermore shown how the conductors 13, 15, 15′ are routed into the hollow shaft portion 11. The current conductors can also be completely or partially potted therein, although this is not shown in FIG. 8. In the example according to FIG. 8, two stranded wires are placed by way of example in each slot and then secured by a plastic cable holder. The shape of the holder 24 is adapted to the stranded-wire diameter and the slot 29 in the shaft 8 and thus ensures an optimum and preferably stress-free extent of the stranded wires, such as the stranded wire 13. The holder for the current conductor(s) can be made from a plastic material. The holders, like the holder 29, can each be fastened on the shaft 8, i.e. on the shaft core 28, by 2×M8 screws (not illustrated in FIG. 8). The holders hold the current conductors, for example stranded wires, in position. Gaps between the shaft 8, the holders and the stranded wires can be filled with potting compound (not illustrated in FIG. 8). After the potting compound has hardened, the region of the shaft is in particular bound and then impregnated with the fully assembled rotor.

FIG. 9 shows a holder 24 for routing the current conductor in the slot. The holder 24 has a base 25 and a cover 26. The current conductor 13 is routed between the base 25 and the cover 26. The current conductor 13 has a curve 35, which has an inflection point 40 in a region between the base 25 and the cover 26. The inflection point is a mathematical term. The term is known from curve sketching. In the inflection point, the 2^{nd} derivation of the considered function of a graph is zero. At the inflection point, the graph, i.e. the curve here, alters the direction of its curvature. As FIG. 9 shows, the holder 24 can be secured by means of a binding 16. By using the holder 24, the placement of the current conductors (for example as stranded wires or as a solid material) can be clearly defined whilst observing the bend radii. The current conductors are sunk in the shaft and the active centrifugal forces caused by rotation are absorbed by the holder, in particular the cover 26 and/or the binding. The load on the current conductors is in particular reduced to a minimum and the formation of cracks can be prevented or reduced. This in turn has the consequence of ensuring the function of the machine, in particular the generator.

FIG. 10 shows an illustration similar to FIG. 7, wherein the fastening of the current conductors on a fastening ring 38 is illustrated from a different perspective. FIG. 10 shows that the slots through the holder 24 are closed in particular such that they are flush with the further surface of the shaft 8. In this case, the cover of the holder 24 is visible from the outside. In one configuration of the shaft, to facilitate the placement of the current conductors, in particular the stranded wires, and to ensure that the minimum bend radii are observed, three slots, one for each phase, are incorporated, in particular milled, into the shaft.

FIG. 11 shows the cover 26 of the holder in a plan view. The cover 26 has prongs 36, 36′, 36″. A space for routing a current conductor is located between the prongs 36 and 36′. This likewise applies to the space between the prongs 36′ and 36″. The cover 26 has protrusions 32 and 32′. A hole, through which a fastening screw (not illustrated) can be guided, is located in these protrusions. Owing to the shape of the holder (which can also be referred to as a cable holder), it is possible to minimize the exit angle of the current conductor. This is achieved in particular since an optimum adaptation to the stranded-wire geometry can be realized in two separate channels. The channels are constructed in particular as grooves, such as are also illustrated in FIGS. 12 and 13. By minimizing the exit angle, it is possible to prevent additional stresses occurring as a result of the bend radii being smaller than the minimum. Contact with sharp edge surfaces of the shaft 8 can also be prevented. The use of the holder 24 also reduces the quantity of the required potting compound which can have a negative effect on the centrifugal forces.

FIG. 12 shows the cover 26 (according to FIG. 11) of the holder looking onto the side which faces the current conductors. It is shown how the prong 36′ merges into a web 37, wherein the web 37 positions and separates the current conductors to be received. FIG. 12 shows a view 39 of the cover 26 from the rear, which is incorporated in the following FIG. 13.

FIG. 13 shows the cover in a rear view, wherein grooves 34, 34′ and the position of the web 37 are clearly evident.

1.-13. (canceled)

14. A shaft, comprising:
a bushing for a current conductor; and
a holder for positioning the current conductor, said holder securing the current conductor in or over an inflection point of a curve of the current conductor.

15. The shaft of claim 14, wherein the holder includes a base and a cover arranged to enable passage of the current conductor there between.

16. The shaft of claim 14, wherein the shaft includes a slot for receiving the current conductor.

17. The shaft of claim 14, wherein the shaft is a shaft of a slip ring rotor.

18. The shaft of claim 16, wherein the shaft includes three of said slots, with each of the three slots provided for a phase.

19. The shaft of claim 18, wherein each of the three slots receives two of said current conductor.

20. The shaft of claim 14, wherein the current conductor is a stranded wire.

21. The shaft of claim 16, wherein the holder is received in the slot.

22. The shaft of claim 14, wherein the holder has a shape which corresponds to a shape of the current conductor.

23. The shaft of claim 14, further comprising a shaft core, said holder being fastened to the shaft core by a screw connection.

24. The shaft of claim 14, wherein the holder is potted.

25. The shaft of claim 14, wherein the current conductor is potted.

26. The shaft of claim 14, further comprising a binding in a region of the holder to secure the holder in place.

27. The shaft of claim 14, wherein the bushing extends at an angle of 20 degrees to 30 degrees with respect to an axis of the shaft.

28. A method for operating a shaft as set forth in claim 14, said method comprising simulating an operation of the shaft.

29. A computer program product for operating a shaft, comprising a computer-executable program embodied in a non-transitory computer readable medium storing computer readable data, wherein the computer-executable program when loaded into a processor of the computer readable medium and executed by the processor causes the processor to carry out a method as set forth in claim 28.
